(19) United States
(12) Patent Application Publication
(10) Pub. No.: US 2020/0287312 A1
(43) Pub. Date: Sep. 10, 2020

(54) HIGH VOLTAGE SUBSEA COUPLING ARRANGEMENT

(71) Applicant: Benestad Solutions AS, Lierskogen (NO)

(72) Inventor: Johannes Arngrim VASSGÅRD, Rasta (NO)

(73) Assignee: Benestad Solutions AS, Lierskogen (NO)

(21) Appl. No.: 16/304,903

(22) PCT Filed: Jun. 2, 2017
(86) PCT No.: PCT/EP2017/063433

§ 371 Date: Nov. 27, 2018

(30) Foreign Application Priority Data
Jun. 3, 2016 (NO) 20160957

(51) Int. Cl. H01R 13/193; H01R 13/523

(52) U.S. Cl. CPC H01R 13/193; H01R 13/523

(57) ABSTRACT

A high voltage, subsea connection assembly having a male part (101) and a female part (1). A radially inwardly facing female electric contact face (25) is axially movable with respect to the housing (5). A male pin (106) moves from a non-connected into a connected position along a first and a succeeding second insertion section. Along the second insertion section, the female contact face (25) is axially aligned and moves with the male electric contact face (113). The female part (1) has a radial actuation means (30) to move the female contact face (25) radially inwards when the female electric contact face (25) moves along the second insertion section, such that the electric contact faces (25, 113) of the male part and the female part, respectively, are forced radially against each other by radial force from the radial actuation means (30).

The present invention relates to a subsea coupling arrangement for high voltage transmission. The coupling arrangement is a wet-mate type arrangement, configured to connect and disconnect in a subsea environment.

### BACKGROUND

A number of challenges arise when designing such subsea power connectors. In particular, as is well known to the skilled person, the combination of high voltage and conducting sea water puts high demands on the connection assembly. Another challenge is to design a connection assembly which will function as intended after a long period of inactivity. For instance, such connectors may remain in a constant position for several years in a subsea environment, after which they need to function as intended.

A common setup for such connection assemblies is to mate a male and a female portion. Typically, a male pin having a contact face is inserted into the female section until the contact face abuts an oppositely facing female contact face. During the movement of the male pin, it is normally an object to avoid or limit insertion of seawater into the female part.

A typical example of such a subsea electrical connection assembly is shown in patent application publication WO2015199550. In this solution, a male and female part are aligned with respect to each other. Then, a male pin supported in the male part is inserted into the female part. The female part has a movable core arranged in a male pin receiving aperture, which is moved axially into the female part upon insertion of the male pin. A male pin contact face faces radially outwards at the front part of the male pin. In a receiving bore of the female part, a radially inwardly facing contact face abuts the male pin contact face, when in the inserted, connected position.

Another typical example of such a subsea electric connection assembly is shown in FR2529396. When inserting the male pin, a movable core is pushed into the female part, letting radially facing contact electric contacts mate with opposite electric contacts in the female bore. The male pin is movably supported within a male housing which is aligned with a female housing before inserting the male pin. At a base end, the male housing is flexibly supported with elastic spacers and resilient sleeves. Thus, the entire male housing may pivot to some extend about its base end. Notably, in the solutions disclosed in FR2529396 and WO2015199550, when inserting the male pin the respective electric contacts will slide against each other until reaching the final, connected position.

Publication DE102012101709 A1 discloses a plug-type connector wherein a first face of the two electrical contact faces is moved simultaneously axially along with and radially into contact with the second part of the electrical contact faces. With this solution, friction due to axial mutual sliding between the two faces is avoided. However, in this solution, the actuation force that moves the both contact faces simultaneously is transferred on the outside of the female housing, making the solution unsuitable for subsea use, due to water ingress.

Repeated friction between the contact faces may be detrimental for the electric coupling. Hence, it may be an object to provide a novel high voltage subsea connection assembly, which avoids such friction between the contact faces. Avoiding such friction will make it possible to use softer materials on the guiding faces, such as gold.

The Invention

According to a first aspect of the present invention, there is provided a high voltage, subsea connection assembly having a male part with a male pin that has a radially outwardly facing male electric contact face, and a female part comprising a female housing and a male pin receiving aperture. Within the female housing, a radially inwardly facing female electric contact face is axially movable with respect to the housing. The male pin is configured to be moved from a non-connected initial position, through the male pin receiving aperture and into a connected final position along a first insertion section and a succeeding second insertion section. Along the first insertion section, the male electric contact face is configured to move axially with respect to the female electric contact face. Moreover, along the second insertion section, the female electric contact face is configured to be axially aligned with and to move axially along with the male electric contact face, as the male pin comprises an actuation face that is configured to provide an actuation force that provides movement of the female electric contact face along the second insertion section. The female part comprises a radial actuation means, which is configured to move the female electric contact face in an inwardly radial direction when the female electric contact face is moved along the second insertion section, such that the electric contact faces of the male part and the female part, respectively, are forced radially against each other by radial force from the radial actuation means.

With the term high voltage is herein meant voltages of 1 kV and above.

In an embodiment of the invention, the female part can comprise a core element configured to move along the first and second insertion sections, wherein the entire or at least a part of the core element is in a position axially between the male pin and an actuation edge when moving along the second insertion section.

The core element is in such an embodiment configured to abut an actuation edge when moving along the second insertion section, thereby being configured to transmit the actuation force from the male pin to the female electric contact face.

That is, during the transition from the first to the second insertion section, the core element will make contact with the actuation edge, and thereby move the contact face of the female part axially along with the core element. The axial movement of the core element is a result of a force from the male pin, which directly or indirectly exerts a moving force, the actuation force, onto the core element. The core element transmits this actuation force to the actuation edge.

The female part can advantageously have a conductor actuation arrangement, which comprises an axial near part that is radially movable and on which the electric contact face is arranged. The conductor actuation arrangement can further have a flexible part, which is configured to transmit axial force to the axial near part.

The flexible part will thus ensure that the axial near part, along with the electric contact face, is moved in the axial direction when moving along the second insertion distance. During this movement, the flexibility of the flexible part ensures that the electric contact face of the female part adapts to the facing electric contact face of the male pin.

The conductor actuation arrangement can further have an axial distant part which is connected to or which carries the actuation edge. This is one way of making the conductor actuation arrangement configured to receive an axially directed force, for axial movement of the conductor actuation arrangement.

In such an embodiment, including the axial distant part with the actuation edge, the axial distant part can have a continuous outer, radially facing face which abuts a sliding current transmission means which is fixed with respect to the housing and which is configured to transmit electric current to the axial distant part.

The sliding current transmission means hence ensures the possibility to transmit electric current into the conductor actuation arrangement, even though the latter is axially movable with respect to the housing of the female part.

The radial actuation means can comprise a first actuation face, which is axially fixed with respect to the female housing and a second actuation face, which is axially fixed with respect to the electric contact face of the female part.

Advantageously, the female part comprises a lift off arrangement, which is configured to lift the electric contact face of the female part off its engagement with the electric contact face of the male pin when the male pin is retraced from a connected position to a non-connected position. In this way, when retracting the male pin from the inserted, connected position, the engaged, facing electrical contact faces can be moved away from each other without any axially directed sliding movement against each other. Advantageously, the lift off arrangement is so configured that it will make the lift off movement at the transition from the second insertion section to the first insertion section, when moving the male pin backwards, i.e. opposite of the insertion direction.

In such an embodiment, the lift off arrangement can comprise a lift off shoulder, which is fixed with respect to the housing and an engaging lift off face which is fixed with respect to the electric contact face of the female part.

The lift off shoulder can be arranged on the axial near part.

According to a second, aspect of the present invention there is provided a high voltage, subsea connection assembly having a male part with an axially movable male pin which has a radially facing electric contact face, and a female part with a housing which has a male pin receiving aperture. According to this aspect of the invention, the housing comprises an axially movable conductor actuation arrangement and an actuation element, which is axially movably with respect to the conductor actuation arrangement. The actuation element is configured to be moved axially from an initial non-connected position to a final connected position along a first and a second insertion distance. In the first insertion distance, the actuation element is configured to be moved with respect to the conductor actuation arrangement and into contact with an actuation face of the conductor actuation arrangement. In the second insertion distance, the actuation element is configured to move together with the conductor actuation arrangement to the final connected position. A radial actuation means is configured to move a radially movable electric contact face of the conductor actuation arrangement in an inwardly radial direction, into contact with the electric contact face of the male pin, during movement along the second insertion distance, as the actuation element is configured to be moved by a force resulting from insertion of the male pin.

In a third aspect of the present invention, there is provided a high voltage, subsea connection assembly having a male part with a male pin and a female part. The female part has a housing with a male pin receiving aperture. Within the housing there is arranged a conductor actuation arrangement which is movable within the housing in an axially inwards direction from a non-connected position to a connected position. The conductor actuation arrangement comprises an axial distant part having an actuation face which is configured for receiving an actuation force, such that the conductor arrangement moves axially inwards towards the connected position when exposed to the actuation force, an axial near part which is radially movable and which comprises a radially inwardly directed electric contact face, and a flexible, axial intermediate part connecting the axial distant part with the axial near part. The axial near part and the housing comprises a radial actuation means with mutually engaging actuation faces, configured to move the electric contact face of the axial near part radially inwards upon movement of the conductor actuation arrangement axially inwards.

Although it is stated that the radial actuation means is part of the axial near part and the female housing, it will be understood that the part of the radial actuation means that is a part of the female housing, may indeed be connected to the housing with an intermediate element.

### EXAMPLE OF EMBODIMENT

While various aspects of the present invention have been discussed in general terms above, a non-limiting, detailed example of embodiment will be given in the following with reference to the drawings, in which

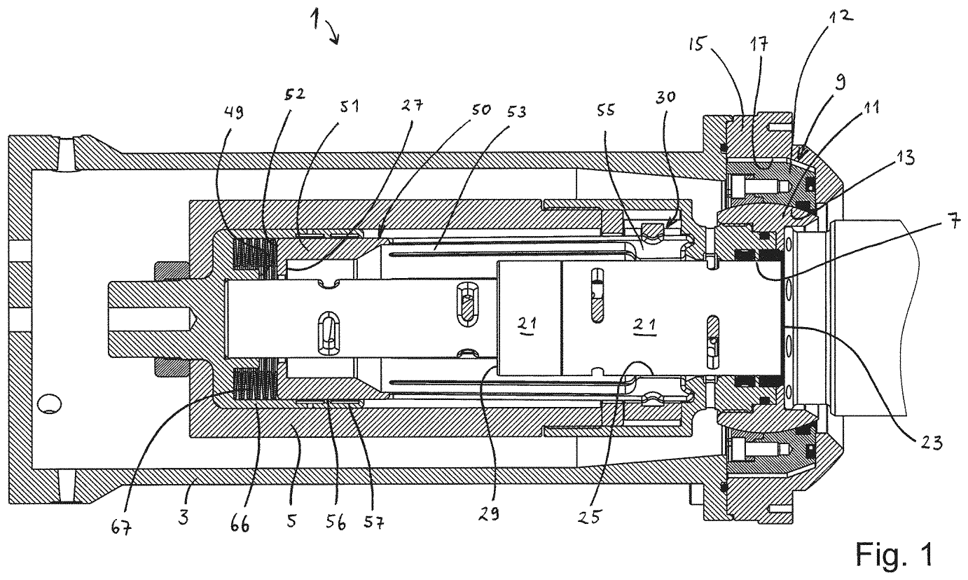

FIG. 1 is a cross section view through a female part of a connection assembly according to the invention, shown in a non-connected state;

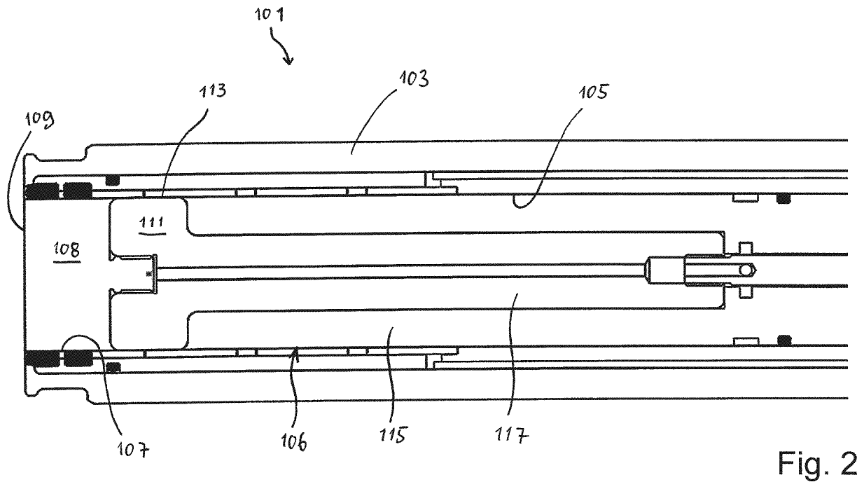

FIG. 2 is a cross section view through a male part of the connection assembly;

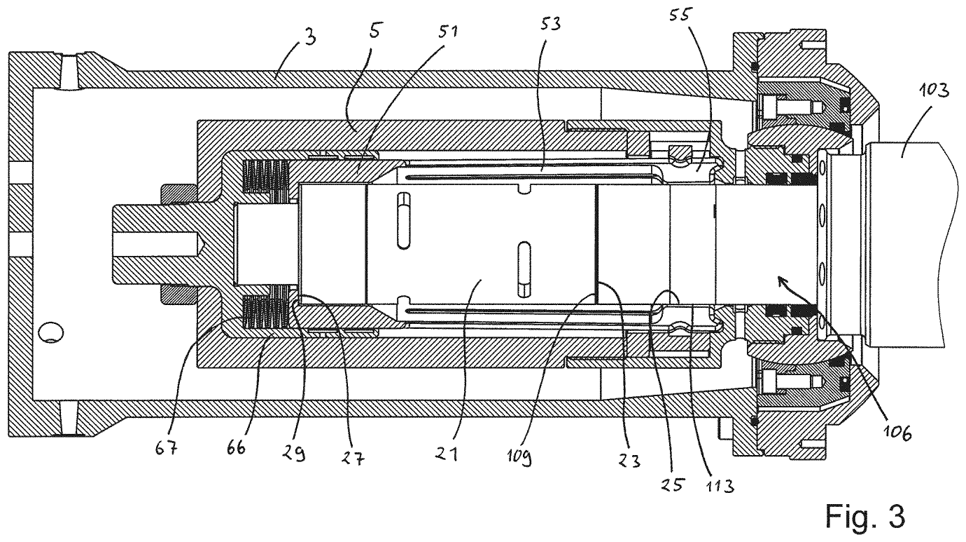

FIG. 3 is a cross section view through the female part, corresponding to FIG. 1, however showing the assembly in an intermediate state;

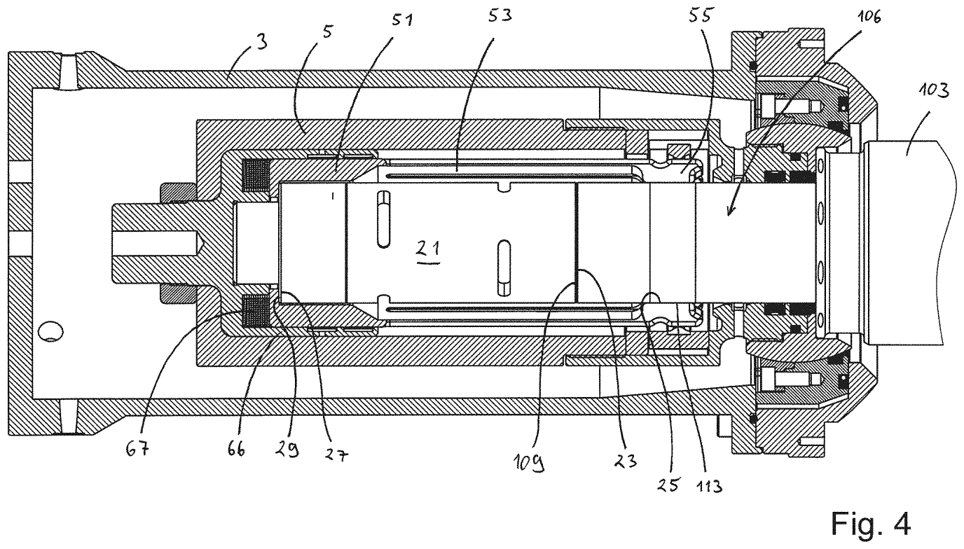

FIG. 4 is another cross section view corresponding to FIG. 1, however showing the assembly in a connected state;

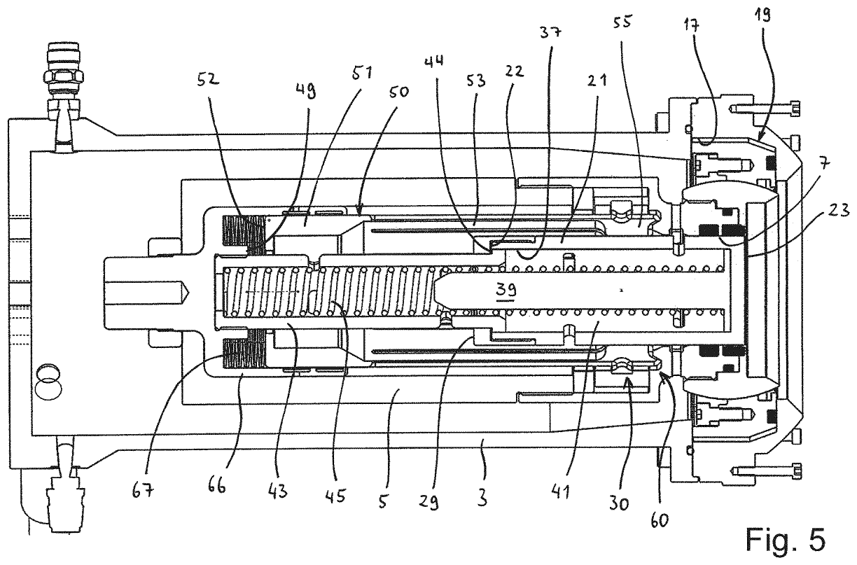

FIG. 5 is another cross section view showing some additional features inside the female part;

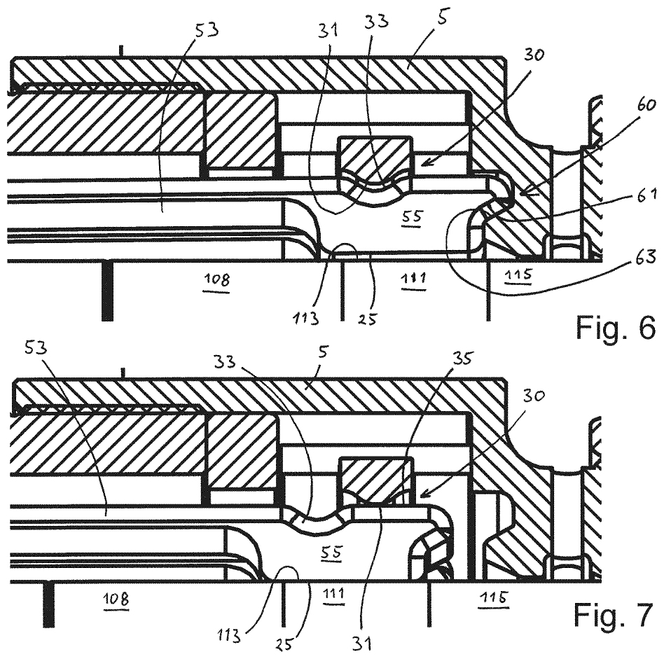

FIG. 6 is an enlarged cross section view of a radial actuation means in the position shown in FIG. 3;

FIG. 7 is an enlarge cross section view of the radial actuation means corresponding to FIG. 6, however illustrating the connected position as in FIG. 4; and

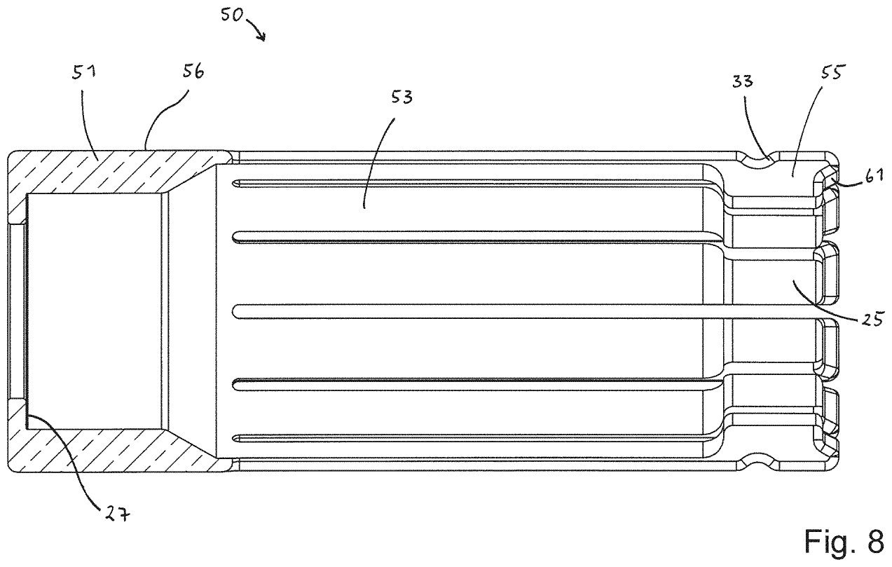

FIG. 8 is a cross section view through a conductor actuation arrangement, here shown separate from the female housing.

FIG. 1 shows a cross section view through a female part 1 of a subsea high voltage connection assembly according to the present invention. In this embodiment, the female part 1 has two housings, namely an outer housing 3 and an inner housing 5. The inner housing 5 has a male pin receiving aperture 7 at an axial outer end.

At the region of the aperture 7, the inner housing 5 is connected to the outer housing 3 via a flexible support arrangement 9. The flexible support arrangement 9 comprises a spherical member 11 supported in a support member 12 with an oppositely configured support face 13. Moreover, the support member 12 is supported in an end section 15 of the outer housing 3 with some radial flexibility. This is achieved by supporting the support member 12 within a support cavity 17 in the end section 15, which is somewhat larger than the outer extension of the support member 12.

In FIG. 1, the female part 1 is shown in a non-connected mode. In this mode, a core element, here in form of a core sleeve 21, is arranged in the male pin receiving aperture 7 of the inner housing 5. The core sleeve 21 has a closed front face 23 which will be in contact with the ambient seawater when it is submerged and the male part is not present. As will appear from the discussion further below, when the male pin is inserted into the female part 1, the front face 23 will abut the male pin, and the entire core sleeve 21 will be pushed axially into the inner housing 5 (to the left in FIG. 1).

The skilled person will appreciate that the force from the male pin 106 onto the core sleeve 21 also could be transmitted through an additional element positioned between the core sleeve 21 and the male pin 106.

The skilled person will appreciate that appropriate seals may be arranged in the female part 1 and the male part 101.

Before a further discussion of the female part 1 is given, reference is made to FIG. 2 for a presentation of a male part 101 which is suited for being used with the female part 1 shown in FIG. 1. The male part 101 has a male housing 103 with an inner male bore 105. Within the male bore 105, there is arranged a male pin 106, which is axially movable, partially out from the male housing 103, through a male housing aperture 107.

The male pin 106 has an actuation face, which in the shown embodiment is the front face 109 of the front portion 108 of the male pin. The front portion 108 is made of an electrically insulating material. Axially behind the front portion 108, the male pin 106 has a conduction portion 111 with radially outwardly facing male electric contact face 113. Axially behind the male electric contact face 113, the male pin 106 has an insulating stem portion 115, which extends axially backwards. The conduction portion 111 is electrically connected to a stem conductor 117 inside the insulating stem portion 115.

Reference is now made to FIG. 3, which illustrates the female part 1 in an intermediate position. This is a position between the initial non-connected position shown in FIG. 1, and a connected position, which is shown in FIG. 4. In the shown intermediate position, the male pin 106 has been inserted into and through the male pin receiving aperture 7, thereby moving the core sleeve 21 along a first insertion distance. In this intermediate position, and during the insertion distance, the actuation face 109 (which is the front face in the shown embodiment) of the male pin 106 abuts the front face 23 of the core sleeve 21. Before commencement of this axial insertion of the male pin 106, the male housing 103 has been aligned with the outer housing 3 and the inner housing 5 of the female part 1. Then, the male pin 106 has been moved in an axial direction, into the female part 1, during which movement, the actuation face 109 of the male pin 106 is in an abutting engagement with the front face 23 of the core sleeve 21.

The male pin receiving aperture 7 constitutes the entrance of the male pin 106 into the inner housing 5.

Referring to FIG. 1 and FIG. 3, attention is now drawn to a conductor actuation arrangement 50 which is provided inside the inner housing 5. Reference is also made to FIG. 5, which depicts some more details of the components inside the female housing. The conductor actuation arrangement 50 is part of the electrically conducting path through the connection assembly. It comprises an axial distant part 51, an axial intermediate part 53 and an axial near part 55. Of these three parts and along the axial direction, the axial near part 55 is arranged nearest to the male pin receiving aperture 7, the distant part 51 is arranged most distant from the male pin receiving aperture 7, and the intermediate part 53 is arranged axially between the axial near part 55 and the distant part 51.

FIG. 3 depicts the intermediate position, which is between a first and a second insertion distance. In this intermediate position, the male electric contact face 113 of the male pin 106 has moved with respect to and has become axially aligned with a radially inwardly facing female electric contact face 25 of the axial near part 55. The facing female and male electric contact faces 25, 113 of the axial near part 55 and the male pin 106, respectively are now ready to become radially moved into engagement with each other. This engagement, namely the contact between the electric contact faces, constitutes the electrical connection point between the female part 1 and the male part 101. This radial movement between the two electric contact faces 25, 113 will take place during movement along the second insertion distance.

As can be appreciated by comparison of the non-connected position of FIG. 1 and the intermediate position shown in FIG. 3, as the male pin 106 moves axially into the female part 1, it moves the core sleeve 21 into engagement with an actuation face, here in the form of an actuation edge 27 of the distant part 51. The core sleeve 21 has an end shoulder 29 which abuts the actuation edge 27 of the conductor actuation arrangement 50.

The skilled person will appreciate that transmission of actuation force, for moving the conductor actuation arrangement 50 axially inwards (away from the male pin receiving aperture 7) also could be provided in another fashion than what is shown in this example.

When moving the core sleeve 21 axially inwards, inside the inner housing 5 of the female part 1, the end shoulder 29 of the core sleeve 21 will contact the actuation edge 27 when the male electric contact face 113 of the male pin 106 is axially aligned with the electric contact face female 25 of the conductor actuation arrangement 50 (i.e. on the axial near part 55). After having reached this position, where the electric contact faces 25, 113 are axially aligned with each other, a further axial movement of the male pin 106 will force and move also the conductor actuation arrangement 50 in an axial direction, along with the male pin 106. This second insertion distance, which constitutes the final distance of the insertion movement of the male pin 106, actuates a radial actuation means 30, which forces the axial near parts 55 and their female electric contact faces 25 in a radial direction into contact with the electric male contact face 113 of the male pin 106. Notably, during this second insertion distance of the insertion movement, there is no mutual axial movement between the two facing electric contact faces 25, 113. Rather, there is only a mutual radial movement, forcing the electric contact faces 25, 113 into close contact with each other, thereby ensuring a good electric coupling. That is, both of the electric contact faces 25, 113 move together in the same axial direction, while becoming forced radially towards each other.

The second insertion distance is illustrated with the difference between FIG. 3 and FIG. 4, as FIG. 3 shows the intermediate position, while FIG. 4 depicts the final, connected position (i.e. the start and end of the second insertion distance, respectively).

Thus, the insertion of the male pin 106, and hence the movement of the core sleeve 21, can be divided into the first insertion distance and the second insertion distance. The first insertion distance is from the initial position, until the end shoulder 29 of the core sleeve 21 first abuts the actuation edge 27 of the conductor actuation arrangement 50 (on the distant part 51 in this embodiment). Thus, the first insertion distance is illustrated with FIG. 1 showing the start and

FIG. 3 showing the end of the first insertion distance. The second insertion distance is from the position where the end shoulder 29 has made contact with the actuation edge 27 (FIG. 3), and to the end position shown in FIG. 4. Hence, along the first insertion distance, the male electric contact face 113 of the male pin 106 moves axially with respect to the female electric contact face 25 of the female part 1. Along the second insertion distance however, the male electric contact face 113 of the male pin 106 moves axially together with the female electric contact face 25 of the female part 1.

The enlarged cross section views of FIG. 6 and FIG. 7 illustrate the function of the radial actuation means 30 in better detail. FIG. 6 and FIG. 7 correspond to the intermediate position and the final position, as shown in FIG. 3 and FIG. 4, respectively. In the intermediate position (FIG. 6), the male pin 106 has been inserted into the inner housing 5 of the female part along the first insertion distance. The electric contact has however still not been established, as the female electric contact face 25 of the female part 1 (i.e. on the radial inner face of the axial near part 55) has not been radially moved into contact with the electric contact face 113 of the male pin 106.

In the non-connected (intermediate) position shown in FIG. 1, the female electric contact face 25 of the conductor actuation arrangement 50, which is positioned on the axial near part 55, is axially at the position of the core sleeve 21, which is of an isolating material. To avoid friction on the female electric contact face 25 of the near end 55, the radial actuation means 30 is in a non-activated state. In this non-activated state, a protrusion 31, cf. also FIG. 6, which is connected to the inner housing 5, protrudes into a recess 33 arranged on the axial near part 55. In this position, there will be no engagement between the protrusion 31 and the recess 33 that forces the female electric contact face 25 onto the core sleeve 21. In FIG. 6, showing the intermediate position, a gap is visible between the male pin 106 and the axial near part 55 (i.e. between the facing female and male electric contact faces 25, 113).

In the connected position however, as shown in FIG. 7, the axial near part 55 and hence the recess 33 have moved axially with respect to the protrusion 31 (second insertion distance). In this position, the protrusion 31 has moved out of its position in the recess 33 and now abuts a contact actuation face 35 on the axial near part 55. Consequently, a radially inwardly directed force is transmitted from the inner housing 5 onto the axial near part 55, which further is transmitted as a radial contact force between the respective electric contact faces 25, 113.

While the radial actuation means 30 described herein is provided with a protrusion and a recess, the radial actuation means 30 may also be provided with other configurations. For instance, instead of a protrusion and recess, one may arrange two inclined faces (which is also the case for the shown embodiment) that slides against each other upon radial movement of the female contact face, without the inclined faces particularly being part of a protrusion and a recess.

The female part 1 also comprises a lift off arrangement 60, which is configured to lift the female electric contact face 25 off the core sleeve 21 and the male pin 106 when in the non-connected position. In the shown embodiment, the lift off arrangement 60 comprises a lift off shoulder 61 on the axial near part 55 which, when in the non-connected position, abuts an inclined lift off face 63 of the inner housing 5. Notably, the lift off arrangement 60 lifts the axial near part 55 of the male pin 106 and the core sleeve 21 when the radial actuation means 30 is in its non-activated position. Thus, when moving in the opposite direction, i.e. from a connected position (“final position”) to an non-connected position (such as the intermediate position), the lift off shoulder 61 will engage the lift off face 63, thereby removing the electric contact faces 25, 113 from each other before they start moving axially with respect to each other.

When the radial actuation means 30 is in its activated position, the lift off arrangement is not activated, thereby letting the radial actuation means 30 force the female electric contact faces 25, 113 into contact. In this non-activated position of the lift off arrangement 60, the lift off shoulder 61 and the lift off face 63 are not engaged, as shown in FIG. 4 and FIG. 7.

Advantageously, a spring means, such as an annular spring, is arranged between the inner housing 5 and the protrusion 33. This provides a biasing force from the protrusion 33 onto the contact actuation face 35. The spring means will become compressed when moving from the not-engaged position shown in FIG. 6, to the engaged (contact) position shown in FIG. 7.

Reference is again made to FIG. 5, for a further description of the components inside the inner housing 5. The core sleeve 21 has an inner bore 37. Centrally within the inner bore 37 there is a core stem 39 which extends axially backwards from the font face 23. The inner bore 37 and the core stem 39 together define a core annulus 41.

A guiding sleeve 43 which is fixed to the inner housing 5, extends from a rear position, into the core annulus 41. Moreover, the core stem 39 extends into the guiding sleeve 43. A spiral spring 45 extends from the inside and rear end of the guiding sleeve 43, to the front end of the core annulus 41. When the male part 101 is not present, or when the male pin 106 is not inserted through the male pin receiving aperture 7 of the inner housing 5, the spring 45 keeps the closed front face 23 of the core sleeve 21 at the front position inside the male pin receiving aperture 7. The forward movement of the core sleeve 21 is stopped in this position by abutting edges 22, 44 of the core sleeve 21 and guide sleeve 43, respectively.

When the core sleeve 21 is moved axially rearwards, towards and into the connected position (cf. FIG. 4), the spring 45 is axially compressed in the annulus between the guiding sleeve 43 and the core stem 39.

As discussed above, the insertion of the male pin 106 from the initial, non-connected position to the final, connected position, can be divided into the first and second insertion distances. At the start of the second insertion distance, the distant part 51 is in the position shown in FIG. 3, as it has not begun to move. At the end of the second insertion section, i.e. at the final inserted position, the distant part 51 is at the position shown in FIG. 4. In this final position, an end face 52 of the distant part 51 abuts against a stopping edge 49 which is fixed with respect to the inner housing 5.

Hence, the distance between the end face 52 and the stopping edge 49 in the initial position, any time before the start movement along the second insertion distance, corresponds to the axial distance by which the axial near part 55 is moved with respect to the inner housing 5.

At an axially inner portion of the inner housing 5, there is arranged a conduction sleeve 66. Between a base portion of the conduction sleeve 66 and the end face 52 of the conductor actuation arrangement 50, there is arranged a spring means 67, here in the form of Belleville springs. The spring means 67 biases the conductor actuation arrangement 50 axially forwards, towards the male pin receiving aperture 7. It becomes axially compressed during movement along the second insertion distance. Conversely, it becomes axially decompressed during the opposite movement, i.e. from the connected position towards the intermediate position.

Positioned between the radially outer face of the distant part 51 and the inner face of the conduction sleeve 66, there are arranged two sliding current transmission means 57. The current transmission means 57 are fixed to the conduction sleeve 66 and are configured to transmit current between the conduction sleeve 66 and the conductor actuation arrangement 50.

The skilled person will appreciate that other embodiments may include only one housing, such as the inner housing 5 without the outer housing 3 of the female part. In the shown embodiment, by using the inner and outer housings 5, 3 one is able to achieve a flexible support of the inner housing 5.

In some embodiment, as the one discussed herein, the axial near part 55 is connected to the axial distant part 51 with an axial intermediate part 53 which is flexible. In this manner, when forcing the axial near part 55 (or parts) and its electric contact face 25 radially against the male pin 106, the orientation of the electric contact face 25 of the axial near part 55 will adapt to the orientation of the electric contact face 113 of the male pin 106. This provides a good electrical connection between the electric contact faces 25, 113.

Preferably, the intermediate part 53 comprises a plurality of axially extending arms that connect a plurality of axial near parts 55 to the axial distant part 51.

The axial distant part 51 can advantageously be shaped as a sleeve or cup, through which the guiding sleeve 43 extends.

Referring back to FIG. 6 and FIG. 7, the protrusions 31 of the radial actuation means 30 can advantageously have a spherical shape, or at least a curved shape. With a spherical shape, the movement of the axial near parts 55, on which the electric contact faces 25 are provided, will be governed by the surface of the opposite electrical contact face 113. That is, the contact elements 55, here in the form of the axial near parts 55, may adopt their orientation by some rotation about any axis extending through them.

Moreover, allowance of such adaptation of orientation of the electric contact faces 25 can also be controlled to some extent by the design of the axial intermediate parts 53. For instance, by using flat cables as the flexible, axial intermediate parts 53, one can allow the axial near parts 55 to pivot about an axis extending circumferentially about the male pin 106. However, the axial near parts 55 could then be made not to pivot about an axis extending in the radial direction.

FIG. 8 is a cross section view through a conductor actuation arrangement 50, here shown separate from the female housing 5 for illustrational purpose. As appears from FIG. 8, in this embodiment the conductor actuation arrangement 50 has an axial distant part 51 which is shaped like a cup or a sleeve, with an actuation edge 27 at its bottom or end. The axial distant part 51 is suited for receiving the core sleeve 21 and an axial force from the same. The axial distant part 51 also has a radially outwardly facing face 56 which, when in use, is configured to abut the sliding current transmission means 57.

The intermediate part 53 is shaped like axially extending fingers that constitute a flexible link between the axial near parts 55 and the axial distant part 51.

The lift off shoulders 61 and the recesses 33 are shown on the axial near parts 55.

1. A high voltage, subsea connection assembly having a male part with a male pin that has a radially outwardly facing male electric contact face, and a female part comprising a female housing and a male pin receiving aperture, wherein, within the female housing, a radially inwardly facing female electric contact face is axially movable with respect to the housing, that the male pin is configured to be moved from a non-connected initial position, through the male pin receiving aperture and into a connected final position along a first insertion section and a succeeding second insertion section;
wherein, along the first insertion section, the male electric contact face is configured to move axially with respect to the female electric contact face;
wherein, along the second insertion section, the female electric contact face is configured to be axially aligned with and to move axially along with the male electric contact face, as the male pin comprises an actuation face that is configured to provide an actuation force, which provides movement of the female electric contact face along the second insertion section; and
wherein, the female part comprises a radial actuation means configured to move the female electric contact face in an inwardly radial direction when the female electric contact face is moved along the second insertion section, such that the electric contact faces of the male part and the female part, respectively, are forced radially against each other by radial force from the radial actuation means.

2. A high voltage, subsea connection assembly according to claim 1, wherein the female part comprises a core element configured to move along the first and second insertion sections, wherein at least a part of the core element is in a position axially between the male pin and an actuation edge when moving along the second insertion section, and is configured to abut an actuation edge when moving along the second insertion section, thereby being configured to transmit the actuation force from the male pin to the female electric contact face.

3. A high voltage, subsea connection assembly according to claim 1, wherein the female part comprises a conductor actuation arrangement which comprises an axial near part which is radially movable and on which the electric contact face is arranged, and a flexible part which is configured to transmit axial force to the axial near part.

4. A high voltage, subsea connection assembly according to claim 2, wherein the conductor actuation arrangement further comprises an axial distant part which is connected to or which carries the actuation edge.

5. A high voltage, subsea connection assembly according to claim 4, wherein the axial distant part has a continuous outer, radially facing face which abuts a sliding current transmission means which is fixed with respect to the female housing and which is configured to transmit electric current to the axial distant part.

6. A high voltage, subsea connection assembly according to claim 1, wherein the radial actuation means comprises a first actuation face which is axially fixed with respect to the housing and a second actuation face which is axially fixed with respect to the electric contact face of the female part.

7. A high voltage, subsea connection assembly according to claim 1, wherein the female part comprises a lift off arrangement which is configured to lift the electric contact face of the female part off its engagement with the electric contact face of the male pin when the male pin is retraced from a connected position to a non-connected position.

8. A high voltage, subsea connection assembly according to claim 7, wherein the lift off arrangement comprises a lift off shoulder which is fixed with respect to the housing and an engaging lift off face which is fixed with respect to the electric contact face of the female part.

9. A high voltage, subsea connection assembly according to claim 3, wherein the lift off shoulder is arranged on the axial near part.
